(19) United States
(12) Patent Application Publication
(10) Pub. No.: US 2025/0254474 A1
(43) Pub. Date: Aug. 7, 2025

(54) HEARING AID WITH INTENTION-BASED NOISE REDUCTION AND BEAMFORMING

(71) Applicant: Oticon A/S, Smørum (DK)

(72) Inventors: Lena NILSSON, Smørum (DK); Michael Noes GÄTKE, Smørum (DK); Nicolai WESTERGREN, Smørum (DK); Karsten BONKE, Smørum (DK); Morten WESTERGAARD, Smørum (DK); Juan Manuel VÖLKER, Smørum (DK); Tanveer BHUIYAN, Smørum (DK); Mohammad EL-SAYED, Hjørring (DK)

(21) Appl. No.: 19/039,796

(22) Filed: Jan. 29, 2025

(30) Foreign Application Priority Data
Feb. 5, 2024 (EP) 24155720.6

(51) Int. Cl. H04R 25/00

(52) U.S. Cl. CPC H04R 25/507; H04R 2225/41; H04R 2225/43; H04R 2225/49

(57) ABSTRACT

Disclosed herein are embodiments of a hearing aid including a dosing mechanism. The dosing mechanism can estimate a dose of a gain reserve based on sensor data, such as accelerometer data, and input signals into the hearing aid. The hearing aid can utilize the estimated dose for setting one or more signal parameters.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids.

### SUMMARY

The present application relates to a hearing aid adapted for being located at or in an ear of a hearing aid user.

The present application further relates to a method.

The present application further relates to a computer program.

In the field of hearing aids there is an increasing awareness towards individual adaptation of the hearing aid settings in order to provide hearing aid users with the most optimal sound experience. A significant goal is to produce and provide hearing aids capable of learning the hearing aid user's individual preferences so that the hearing aids can deliver the most efficient listening experience to hearing aid users.

In other words, an important aspect is the possibility of providing more noise reduction and directionality based on the intention of the hearing aid user. However, too easy access to this extra help may introduce artefacts as well as disturb the hearing aid user in situations where the intention was misinterpreted.

Therefore, it is essential to ensure that the extra help is only given in challenging acoustical environments while engaging in conversation.

A hearing aid:

In an aspect of the present application, a hearing aid is provided.

The hearing aid may be adapted to being located at or in an ear of a hearing aid user.

The hearing aid may comprise an input unit for receiving an input sound signal from an acoustic environment of a hearing aid user.

The input unit may be configured to provide at least one electric input signal representing said input sound signal.

The input unit may comprise an input transducer, e.g. a microphone, for converting said input sound signal to an electric input signal. The input unit may comprise a wireless receiver for receiving a wireless signal comprising or representing sound and for providing an electric input signal representing said sound.

The hearing aid may comprise an output unit for providing at least one set of stimuli perceivable as sound to the hearing aid user based on processed versions of said at least one electric input signal.

The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise a processor configured to process said at least one electric input signal based on a baseline gain.

Baseline gain may refer to a pre-set gain level as determined based on e.g. an audiogram.

The hearing aid may comprise a sensor member for detecting a motion of the hearing aid user.

The hearing aid may comprise a sensor member for detecting an orientation of the hearing aid user's head.

The sensor member may comprise an accelerometer configured to provide accelerometer data.

The accelerometer may be configured to detect a movement of the hearing aid user.

The accelerometer may be configured to detect movement in a vertical and/or in a horizontal direction.

The accelerometer may be configured to detect the movement and/or acceleration and/or orientation and/or position of the hearing aid user.

The accelerometer may be configured to detect accelerations in one, two, or three distinct spatial directions. The accelerometer may be configured to detect accelerations in three spatial directions including an x-direction, a y-direction, and a z-direction.

For example, the sensor member may be configured to detect movement/motion of the user's facial muscles and/or bones, e.g. due to speech or chewing (e.g. jaw movement) and to provide a detector signal indicative thereof.

The hearing aid may comprise a dosing mechanism configured to estimate a dose of gain reserve.

The dosing mechanism may be configured to estimate said dose of gain reserve based on the accelerometer data and said at least one electric input signal.

The dosing mechanism may be adapted to dose the gain reserve (extra gain) in a way that benefits most the end-user by taking into consideration the intent of the user, the personal need of the user, the listening preferences of the user, and the acoustic environment of the hearing aid user.

The hearing aid may be configured to set signal processing parameters of the processor based on the baseline gain and the estimated dose of gain reserve.

Thereby, it is provided that extra help is only given in challenging acoustical environments while the hearing aid user is engaging in a conversation.

The accelerometer data may comprise at least one signal representing said movement in X-, Y-, and Z-axes of an X-Y-Z co-ordinate system.

The hearing aid may be configured to translate the accelerometer data to quantify said movement and/or orientation as counts in said X-, Y-, and Z-axes.

The hearing aid may be further configured to separate lateral head movements defined as counts in said X- and Y-axes and vertical head movements defined as counts in the X- and Z-axes.

The hearing aid may be configured to filter the accelerometer data by calculating at least a sample-by-sample minimum of the counts in said X- and Y-axes.

The dosing mechanism may comprise a plurality of blocks/modules/units.

Block may within the application refer to a unit or a module.

Thus, a block may refer to a software module/unit, or may refer to a physical unit/module in the hearing aid.

The plurality of blocks may comprise at least a first block configured to process the accelerometer data and provide a motion-based probability.

The plurality of blocks may comprise at least a first block configured to process the accelerometer data and provide a motion-based control mechanism.

The plurality of blocks may comprise a second block configured to process the at least one electric input signal and provide an audio-based probability.

The plurality of blocks may comprise a second block configured to process the at least one electric input signal and provide an audio-based control mechanism.

The dosing mechanism may be configured to estimate said dose of gain reserve based on at least the motion-based probability (or control mechanism) and the audio-based probability (or control mechanism).

The hearing aid may be configured to determine a motion bias from said sample-by-sample minimum of the counts in said X- and Y-axes.

The motion-based probability may be calculated from said motion bias.

Thus, in case the motion bias is 1, the hearing aid may be configured to estimate that the user's listening intention is full focus (e.g., one-to-one conversation). In this case, the motion-based probability may be 1.

For example, in case the motion-based probability is 1, the processor of the hearing aid (or the hearing aid) may be configured to set the signal processing parameters (of the processor) to provide an increased level of directionality and/or noise reduction.

Thus, in case the motion bias is 0, the hearing aid may be configured to estimate that the user's listening intention is not full focus. In this case, the motion-based probability may be 0.

For example, in case the motion-based probability is 0, the processor of the hearing aid (or the hearing aid) may be configured to set the signal processing parameters (of the processor) to provide default directionality and/or noise reduction.

In other words, the hearing aid may be configured to evaluate the lateral head movements defined as counts in said X- and Y-axes and the vertical head movements defined as counts in the X- and Z-axes.

In case the counts in said X- and Y-axes are below a threshold, the dosing mechanism (and/or the first block) may set the motion bias (and therefore the motion-based probability) to 1.

In case the counts in said X- and Y-axes are above a threshold, the dosing mechanism (and/or the first block) may set the motion bias (and therefore the motion-based probability) to 0.

The change of motion bias (and therefore of the motion-based probability), when passing the threshold, may be set to be a gradual change with a preset rate/ramping. Thereby, the change in motion bias (and therefore of the motion-based probability) will be a gradual change, which will result in a gradual change of dose of gain reserve.

The baseline gain may be based on at least a predetermined audiogram of the hearing aid user. For example, the baseline gain may be determined from a Hearing Threshold Level (HTL) estimated from a predetermined audiogram of the hearing aid user.

The first block may be configured to estimate the motion-based probability (or control mechanism) based on a motional behavior of the hearing aid user.

The motional behavior of the hearing aid user may be estimated from said accelerometer data.

A motion-based probability of 0 may indicate that the hearing aid user is not focused.

For example, the motion-based probability may be set to 0 when said accelerometer data indicates movement above a threshold.

A motion-based probability of 1 may indicate that the hearing aid user is focused.

For example, the motion-based probability may be set to 1 when said accelerometer data indicates movement below the threshold.

The hearing aid may comprise an own voice detector (OVD).

The OVD may repeatedly estimate whether or not, or with what probability, said at least one electric input signal, or a signal derived therefrom, comprises a speech signal originating from the voice of the hearing aid user.

The OVD may provide an own voice control signal indicative thereof.

In other words, the OVD is adapted to estimate whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The hearing aid may further comprise a voice activity detector (VAD).

The VAD may repeatedly estimate whether or not, or with what probability, said at least one electric input signal, or a signal derived therefrom, comprises one or more speech signals from speech sound sources other than the hearing aid user.

The VAD may provide a voice activity control signal indicative thereof.

In other words, the VAD is adapted to estimate whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The second block may be configured to estimate the audio-based probability (or control mechanism) based on said own voice control signal.

The second block may be configured to estimate the audio-based probability (or control mechanism) based on said voice activity control signal.

The second block may be configured to estimate the audio-based probability (or control mechanism) based on both said own voice control signal and said voice activity control signal.

An audio-based probability of 1 may indicate the presence of speech signals originating from the voice of the hearing aid user.

An audio-based probability of 1 may indicate the presence of speech signals from speech sound sources other than the hearing aid user in a look direction of the hearing aid user.

The hearing aid may further comprise a signal-to-noise ratio (SNR) estimator.

The SNR estimator may be configured to determine SNR in the acoustic environment of the hearing aid user.

The dosing mechanism may comprise a third block.

The third block may be configured to process the at least one electric input signal.

The said third block may be configured to estimate a further audio-based probability (or control mechanism) based at least on said SNR.

The said third block may be configured to estimate a further audio-based probability (or control mechanism) based at least on an audible contrast threshold (ACT), such as an ACT value (e.g., a normalized contrast threshold (nCL) value).

The hearing aid may further comprise a neural network.

For example, the neural network may be a deep neural network.

For example, the hearing aid may be configured to estimate the dose of gain reserve, and/or set signal processing parameters by use of the neural network.

The third block may be configured to estimate the audio-based probability (or control mechanism) by use of the neural network.

The dosing mechanism may be configured to estimate the dose of gain reserve by multiplying the gain reserve with the product of the motion-based probability (or control mechanism) of said first block and the audio-based probability (or control mechanism) of said second or third block.

The dosing mechanism may be configured to estimate the dose of gain reserve by at least multiplying the gain reserve with the product of the motion-based probability (or control mechanism), the audio-based probability (or control mechanism) of said second block, and the audio-based probability (or control mechanism) of said third block.

The dosing mechanism may be configured to estimate to estimate the resulting gain provided to the hearing aid user based on the sum of the of the baseline gain and the estimated dose of gain reserve.

For example, the gain reserve may be 1 dB, 2 dB, or 3 dB.

For example, the gain reserve may be >2 dB.

The hearing aid may be configured to set the signal processing parameters of the processor.

Setting (and further optimizing) signal processing parameters may comprise controlling and enhancing the intention-based beamforming.

Setting (and further optimizing) signal processing parameters may comprise increasing and optimizing the intention-based noise reduction.

For example, increasing and optimizing the intention-based noise reduction may comprise different noise classification levels, regulating SNR levels, and/or optimizing directionality based on the resulting gain as the sum of the baseline gain and the estimated dose of gain reserve.

In other words, the hearing aid may comprise conversation and environment complexity detectors to control and enhance intention-based noise reduction and beamforming performance.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user.

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. The processor (signal processor) may be located in the forward path. The processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively, or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a classification unit configured to classify the current situation based on input signals from (at least some of) the detectors (e.g., the sensor member, SNR estimator, etc.), and possibly other inputs as well. In the present context ‘a current situation’ may be taken to be defined by one or more of

a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a recurrent neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

Use:

In an aspect, use of a hearing aid as described above, in the ‘detailed description of embodiments’ and in the claims, is moreover provided. Use may be provided in a system comprising one or more hearing aids (e.g. hearing instruments), headsets, ear phones, active ear protection systems, etc., e.g. in handsfree telephone systems, teleconferencing systems (e.g. including a speakerphone), public address systems, karaoke systems, classroom amplification systems, etc.

A method:

In an aspect, a method is furthermore provided by the present application.

The method may comprise receiving an input sound signal from an acoustic environment of a hearing aid user.

The method may comprise providing at least one electric input signal representing said input sound signal.

The method may comprise providing at least one set of stimuli perceivable as sound to the hearing aid user based on processed versions of said at least one electric input signal.

The method may comprise processing said at least one electric input signal based on a baseline gain.

The method may comprise detecting a motion of the hearing aid user and/or an orientation of the hearing aid user's head by a sensor member comprising an accelerometer configured to provide accelerometer data.

The method may comprise estimating a dose of gain reserve based on the accelerometer data and said at least one electric input signal.

The method may comprise setting signal processing parameters of the processor based on the baseline gain and the estimated dose of gain reserve.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aids.

A computer readable medium or data carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

A computer program:

In an aspect, a computer program (product) comprising instructions which, when the program is executed by a computer, cause the computer to carry out (steps of) the method described above, in the ‘detailed description of embodiments’ and in the claims is furthermore provided by the present application.

In other words, the computer program may comprise instructions which, when the program is executed by a processor of a hearing aid, cause the hearing aid to perform at least the steps of:
processing at least one electric input signal based on a baseline gain,
estimating a dose of gain reserve based on accelerometer data and said at least one electric input signal, and
setting signal processing parameters based on the baseline gain and the estimated dose of gain reserve.

A data processing system:

In an aspect, a data processing system comprising a processor and program code means for causing the processor to perform at least some (such as a majority or all) of the steps of the method described above, in the ‘detailed description of embodiments’ and in the claims is furthermore provided by the present application.

A hearing system:

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

An APP:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g. a smartphone, or on another portable device allowing communication with said hearing aid or said hearing system.

Definitions:

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows a diagram flow of the dosing mechanism for the gain reserve.

FIG. 2 shows an example of dosing of gain reserve according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

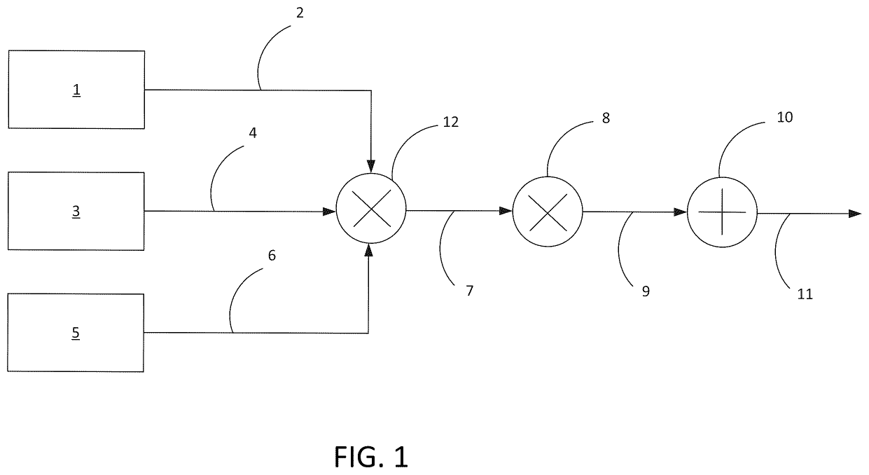

FIG. 1 illustrates a diagram flow of the dosing mechanism for the gain reserve.

It is shown that the dosing mechanism may comprise a plurality of blocks comprising at least a first block 1 configured to process accelerometer data and provide a motion-based probability (or control mechanism) 2 and a second block 3 configured to process the at least one electric input signal and provide an audio-based probability (or control mechanism) 4.

Based on at least the motion-based probability 2 and the audio-based probability 4, the dosing mechanism may be configured to estimate said dose of gain reserve. The first block 1 may determine the motion-based probability 2 based on a motional behaviour of the hearing aid user as estimated from said accelerometer data.

If all negative outputs from the first block 1 is forced to zero, then the block estimates a probability (based on the motional behavior) of the hearing aid user being focused (potentially focused on a conversation, but it requires more information to be certain about what the end-user is focusing on).

If the output of the first block 1 (the motion-based probability 2) is zero, then the motional behavior of hearing aid user suggests that the user is not focused (from a movement point of view).

If the output of the first block 1 (the motion-based probability 2) is one, then the motional behavior of the end-user strongly indicates that the user is focused (potentially focused on the conversation).

The second block 3 may be configured to estimate the audio-based probability 4 based on an own voice control signal (from an OVD) and/or a voice activity control signal (from a VAD). Thereby, the second block 3 can be exemplified as a block capable of estimating the audio-based probability 4 (i.e., a conversation probability) of the user participating in a conversation by utilizing own-voice detection and voice activity detection.

The audio-based probability 4 may converge to one, if either speech from front (i.e., the look direction of the hearing aid user) or own voice is detected. The audio-based probability 4 may converge to zero if neither of them are detected.

Alternatively, or additionally, the hearing aid may estimate the correlation between own-voice and a plurality of speech streams to indicate if the hearing aid user is in a conversation with either of the speech streams.

The motion-based probability 2 and the audio-based probability 4 (of the second block 3) may be multiplied together to give a joint probability. Said probabilities 2,4 are assumed to be statistically independent. The joint probability can be seen as the probability of the hearing aid user being in a focused conversation. For example, the joint probability may be zero, if the user sits and reads a book (even though the motion-based probability 2 indicates that the user is focused). Thereby, the joint probability allows the exclusion of such situations, which would be impossible if only based on the motion-based probability 2.

It is shown that the dosing mechanism may further comprise a third block 5. The third block 5 may be configured to estimate a further audio-based probability (or control mechanism) 6 based at least on an SNR and/or on an audible contrast threshold (ACT). Therefore, said audio-based probability 6 can indicate if the user is in an acoustic environment where it would be beneficial to utilize the gain reserve (may be personalized based on the hearing profile of the hearing aid user). For example, hearing aid users may be grouped into help-profiles based on their personal preferences for when and how much gain reserve should be introduced. The personalization procedure for each hearing aid user can be achieved with an appropriate questionnaire capable of detecting personal listening preferences and needs, or via the ACT testing.

The ACT testing is a tool providing the healthcare professionals with an efficient insight into hearing aid users' ability to listen in various noisy environments, in terms of sound content and complexity, thereby estimating how much additional help the hearing aid user may require.

The reasoning behind estimating said further audio-based probability 6 is that the acoustic environment of the hearing aid user is required to be with some degree of complexity before the user benefits from the “additional help”.

For example, the hearing aid may comprise a neural network for the estimating said audio-based probability 6.

As shown in FIG. 1, the dosing mechanism may comprise a first multiplication unit 12. The multiplication unit 12 may be configured to multiply the motion-based probability 1 with the audio-based probability 3 of said second block 2. The resulting product may give an indication of the hearing aid user participating in a focused conversation. In the case that the hearing aid user sits and reads a book, this probability is calculated to be zero.

The first multiplication unit 12 may be configured to multiply said resulting product with the further audio-based probability 6 of the third block 5. The probabilities 2, 4, 6 are assumed statistically independent. The resulting probability 7 may exemplified the probability of the hearing aid user being in a focused conversation in a noise listening environment.

For example, in case the resulting probability 7 is zero, then the dose of gain reserve is not used. In case the resulting probability 7 is 0.5, then half of the dose of gain reserve is used. In case the resulting probability 7 is 1, then the entire dose of gain reserve is used.

As shown in FIG. 1, the dosing mechanism may comprise a second multiplication unit 8. The second multiplication unit 8 may be configured to multiply the resulting probability 7 with the gain reserve, thereby estimating the dose of gain reserve 9.

As shown in FIG. 1, the dosing mechanism may further comprise an adder 10. The adder 10 may be configured to sum the estimated dose of gain reserve 9 and a baseline gain (e.g. the baseline gain may be 6 dB) as determined based on a predetermined audiogram of the hearing aid user.

Lastly, the dosing mechanism may output a resulting gain (help) 11 that is provided to the hearing aid user based on the sum of the baseline gain 10 and the estimated dose of gain reserve 9.

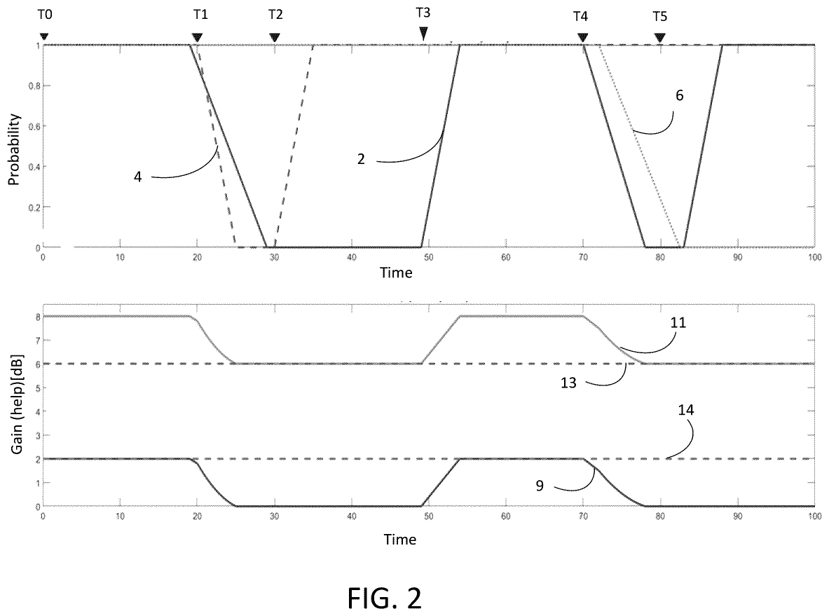

FIG. 2 shows an example of dosing of gain reserve according to the present disclosure.

The top graph FIG. 2 illustrates different listening situations and corresponding motion-based 2, first audio-based 4, and second audio-based probabilities 6, respectively, as a function of time.

In the lower graph of FIG. 2 the correlation between said probabilities 2,4,6 and the dose of gain reserve and resulting gain 11 (“resulting help”), respectively, is shown as function of time. The resulting gain 11 provided to the hearing aid user is shown to be based on the sum of the baseline gain 13 (which in FIG. 2 is shown to be 6 dB) and the estimated dose of gain reserve 9. The estimated dose of gain reserve 9 is shown to be a part of a maximum gain reserve 14 (which in FIG. 2 is shown to be 2 dB).

In FIG. 2, six different points in time T0-T5 are shown.

At T0, the hearing aid user may be at a party participating in a one-to-one conversation. The motion-based probability 2 (marked as blue) and the first 4 and second audio-based probabilities 6 (marked as green and red, respectively) are all estimated to be 1. Accordingly, the resulting gain 11 (marked as green) provided to the hearing aid user is 8 dB, as a consequence of the baseline gain 13 (marked as red) being 6 dB and the dose of gain reserve 9 (marked as blue) being 2 dB.

At T1, the hearing aid user starts walking around, while the conversation stops. The second audio-based probability 6 remains to be 1 but the other two probabilities are reduced gradually. Accordingly, the dose of gain reserve 9, and therefore the resulting gain 11, starts dropping until firstly the first audio-based probability 4 and secondly the motion-based probability 2 reaches 0. At this point, the dose of gain reserve equals 0 for which reason the resulting gain 11 equals the baseline gain 13 (6 dB).

At T2, the hearing aid user stops walking and instead participates in a group conversation. Therefore, the first audio-based probability 4 starts increasing, but as the motion-based probability 2 remains 0 for which reason the resulting gain 11 still equals the baseline gain 13 (6 dB).

At T3, the hearing aid user starts having a focused conversation with one from the group. Therefore, the motion-based probability 2 starts increasing for which reason the dose of gain reserve 9, and therefore the resulting gain 11, starts increasing. At some point, the motion-based probability 2 equals 1 resulting in that the dose of gain reserve 9 equals the maximum gain reserve 14. At this point, the resulting gain 11 is at the maximum of 8 dB.

At T4, the hearing aid user continues to have a focused conversation while walking to a quiet place. Therefore, firstly the motion-based probability 2 and secondly the second audio-based probability 6 starts dropping, for which reason the dose of gain reserve 9 and the resulting gain 11 starts dropping. At some point, the motion-based probability 2 equals 0 resulting in that the dose of gain reserve equals 0, and thus the resulting gain 11 equals the baseline gain (6 dB).

At T5, the hearing aid user stops walking and has a one-to-one conversation in a quiet place. Therefore, the motion-based probability 2 starts increasing. However, as the conversation is taking place in a quiet place and additional help therefore is not required, the second audio-based probability 6 remains 0 for which reason the dose of gain reserve 9 remains 0.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. Hearing aid adapted for being located at or in an ear of a hearing aid user, the hearing aid comprising:
an input unit for receiving an input sound signal from an acoustic environment of a hearing aid user and providing at least one electric input signal representing said input sound signal,
an output unit for providing at least one set of stimuli perceivable as sound to the hearing aid user based on processed versions of said at least one electric input signal,
a processor configured to process said at least one electric input signal based on a baseline gain,
a sensor for detecting a motion of the hearing aid user and/or an orientation of the hearing aid user's head, where the sensor comprises an accelerometer configured to provide accelerometer data, and
a dosing mechanism configured to estimate a dose of gain reserve,
wherein the dosing mechanism is configured to estimate said dose of gain reserve based on the accelerometer data and said at least one electric input signal, and
wherein the hearing aid is configured to set signal processing parameters of the processor based on the baseline gain and the estimated dose of gain reserve.

2. Hearing aid according to claim 1, wherein the dosing mechanism is configured to process the accelerometer data and provide a motion-based probability and is configured to process the at least one electric input signal and provide an audio-based probability, wherein the dosing mechanism is configured to estimate said dose of gain reserve based on at least the motion-based probability and the audio-based probability.

3. Hearing aid according to claim 1, wherein the baseline gain is based on at least a predetermined audiogram of the hearing aid user.

4. Hearing aid according to claim 2, wherein said dosing mechanism is configured to estimate the motion-based probability based on a motional behavior of the hearing aid user as estimated from said accelerometer data, where the motion-based probability is set to 0 when said accelerometer data indicates movement above a threshold, and where the motion-based probability is set to 1 when said accelerometer data indicates movement below the threshold.

5. Hearing aid according to claim 1, wherein the hearing aid further comprises an own voice detector (OVD) for repeatedly estimating whether or not, or with what probability, said at least one electric input signal, or a signal derived therefrom, comprises a speech signal originating from the voice of the hearing aid user, and providing an own voice control signal indicative thereof.

6. Hearing aid according to claim 1, wherein the hearing aid further comprises a voice activity detector (VAD) for repeatedly estimating whether or not, or with what probability, said at least one electric input signal, or a signal derived therefrom, comprises one or more speech signals from speech sound sources other than the hearing aid user, and providing a voice activity control signal indicative thereof.

7. Hearing aid according to claim 5, wherein said dosing mechanism is configured to estimate the audio-based probability based on said own voice control signal and/or said voice activity control signal.

8. Hearing aid according to claim 7, wherein an audio-based probability of 1 indicates the presence of speech signals originating from the voice of the hearing aid user and/or indicates the presence of speech signals from speech sound sources other than the hearing aid user in a look direction of the hearing aid user.

9. Hearing aid according to claim 1, wherein the hearing aid further comprises a signal-to-noise ratio (SNR) estimator configured to determine SNR in the acoustic environment of the hearing aid user.

10. Hearing aid according to claim 1, wherein the dosing mechanism is configured to process the at least one electric input signal, and is configured to estimate a further audio-based probability based at least on said SNR and/or on an audible contrast threshold (ACT).

11. Hearing aid according to claim 1, wherein the hearing aid further comprises a neural network.

12. Hearing aid according to claim 11, wherein said dosing mechanism is configured to estimate the audio-based probability by use of the neural network.

13. Hearing aid according to claim 1, wherein the dosing mechanism is configured to estimate the dose of gain reserve by multiplying the gain reserve with the product of the motion-based probability and one or more of the audio-based probability.

14. Hearing aid according to claim 1, wherein setting and further optimizing the signal processing parameters comprises controlling and enhancing the intention-based beamforming, increasing and optimizing the intention-based noise reduction, in terms of different noise classification levels, regulating SNR levels, and/or optimizing directionality based on the baseline gain and the estimated dose of gain reserve.

15. A method comprising:
receiving an input sound signal from an acoustic environment of a hearing aid user,
providing at least one electric input signal representing said input sound signal,
providing at least one set of stimuli perceivable as sound to the hearing aid user based on processed versions of said at least one electric input signal,
processing said at least one electric input signal based on a baseline gain,
detecting a motion of the hearing aid user and/or an orientation of the hearing aid user's head by a sensor comprising an accelerometer configured to provide accelerometer data,
estimating a dose of gain reserve based on the accelerometer data and said at least one electric input signal, and
setting signal processing parameters of the processor based on the baseline gain and the estimated dose of gain reserve.

16. Computer program comprising instructions which, when the program is executed by a processor of a hearing aid according to claim 1, cause the hearing aid to perform at least the steps of:
processing at least one electric input signal based on a baseline gain,
estimating a dose of gain reserve based on accelerometer data and said at least one electric input signal, and
setting signal processing parameters based on the baseline gain and the estimated dose of gain reserve.
